(19) United States
(12) Patent Application Publication
(10) Pub. No.: US 2026/0289103 A1
(43) Pub. Date: Sep. 24, 2026

(54) IMAGE AND TEXT TYPESETTING METHOD AND APPARATUS, MEDIUM, AND ELECTRONIC DEVICE

(71) Applicant: Beijing Zitiao Network Technology Co., Ltd., Haidian District, Beijing (CN)

(72) Inventors: Maoke YANG, Beijing (CN); Hao XUE, Beijing (CN)

(21) Appl. No.: 19/490,832

(22) PCT Filed: Jun. 3, 2024
(86) PCT No.: PCT/CN2024/096949

§ 371 Date: Dec. 5, 2025

(30) Foreign Application Priority Data
Jun. 6, 2023 (CN) 202310667291.9

(51) Int. Cl. G06F 40/189; G06T 3/40; G06T 7/194

(52) U.S. Cl. CPC G06F 40/189; G06T 3/40; G06T 7/194; G06T 2207/20132

(57) ABSTRACT

The present disclosure relates to an image and text typesetting method and apparatus, a medium, and an electronic device. The image and text typesetting method comprises: obtaining a saliency map on the basis of a background base image; incorporating material to be arranged, searching on the saliency map to obtain candidate boxes of said material; determining saliency values of the candidate boxes; and on the basis of the saliency values, determining a placement position of said material from among the candidate boxes.

### CROSS-REFERENCE TO RELATED APPLICATIONS

The present application is based on and claims priority to a Chinese application with an application number 202310667291.9 and a filing date of Jun. 6, 2023, the aforementioned application is hereby incorporated by reference in its entirety.

### TECHNICAL FIELD

The present disclosure relates to the field of computer technology, and in particular to an image and text typesetting method, apparatus, medium and electronic device.

### BACKGROUND

In the current automatic image and text poster generation technology, algorithms such as Generative Adversarial Network (GAN) are usually used to generate the arrangement between text boxes.

### SUMMARY

This SUMMARY is provided to introduce concepts in a simplified form, and such concepts will be described in detail in the following DETAILED DESCRIPTION. This SUMMARY is not intended to identify key features or essential features of the claimed technical solution, nor is it intended to be used to limit the scope of the claimed technical solution.

In a first aspect, the present disclosure provides an image and text typesetting method, including: acquiring a saliency map based on a background base image; searching on the saliency map in combination with material to be laid out, to obtain candidate boxes for the material to be laid out; determining saliency values of the candidate boxes; determining a placement position of the material to be laid out from the candidate boxes, based on the saliency values.

In a second aspect, the present disclosure provides an image and text typesetting apparatus, including: an acquisition module, configured to acquire a saliency map based on a background base image; a searching module, configured to search on the saliency map in combination with material to be laid out, to obtain candidate boxes for the material to be laid out; a first determination module, configured to determine saliency values of the candidate boxes; a second determination module, configured to determine a placement position of the material to be laid out from the candidate boxes, based on the saliency values.

In a third aspect, the present disclosure provides a computer-readable medium storing a computer program thereon, wherein the computer program, when executed by a processing device, cause implementation of steps of any method as described in the above first aspect of the present disclosure.

In a fourth aspect, the present disclosure provides an electronic device, including a storage device storing a computer program thereon, and a processing device, configured to execute the computer program in the storage device to implement steps of any method as described in the above first aspect of the present disclosure.

In a fifth aspect, the present disclosure provides a computer program product including instructions which, when executed by a processor, causes the processor to implement steps of any method as described in the above first aspect of the present disclosure.

In a sixth aspect, the present disclosure provides a computer program including program codes, which, when executed by a processor, cause implementation of steps of any method as described in the above first aspect of the present disclosure.

Other features and advantages of the present disclosure will be described in detail in the following DETAILED DESCRIPTION section.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a flow chart of an image and text typesetting method according to an embodiment of the present disclosure.

FIG. 2 shows a schematic diagram of a background base image and its corresponding saliency map.

FIG. 3 is another flow chart of an image and text typesetting method according to an embodiment of the present disclosure.

FIG. 4 is another flow chart of an image and text typesetting method according to an embodiment of the present disclosure.

FIG. 5 shows a schematic diagram of extracting candidate boxes of multiple scales using a sliding window pyramid.

FIG. 6 is a schematic diagram of placement positions of materials to be laid out according to an embodiment of the present disclosure.

FIG. 7 is a schematic block diagram of an image and text typesetting apparatus according to an embodiment of the present disclosure.

FIG. 8 is a schematic block diagram of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as being limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”; the term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

Names of messages or information exchanged between multiple apparatuses in the embodiments of the present disclosure are only for illustrative purposes, and are not intended to limit the scope of these messages or information.

It may be understood that before using the technical solutions disclosed in the embodiments of the present disclosure, a user should be informed of the type, range of usage, usage scenario, etc. of personal information involved in the present disclosure in an appropriate manner in accordance with relevant laws and regulations, and the authorization of the user should be obtained.

For example, in response to receiving an active request from a user, prompt information is sent to the user to clearly inform the user that the operation requested to be performed will require access to and usage of the user's personal information. In this way, the user may independently choose whether to provide the personal information to software or hardware such as an electronic device, an application, a server, or a storage medium that performs the operation of the technical solution of the present disclosure according to the prompt information.

As an alternative but non-limiting implementation, in response to receiving an active request from the user, the prompt information may be sent to the user in the form of a pop-up window, for example, and the prompt information may be presented in text in the pop-up window. In addition, the pop-up window may further include a selection control for the user to choose whether to “agree” or “disagree” to provide the personal information to the electronic device.

It may be understood that the above process of notifying and acquiring the authorization from the user is merely illustrative and is not intended to limit the implementations of the present disclosure. Other manners that satisfy the requirements of relevant laws and regulations may also be applied to the implementations of the present disclosure.

In addition, it may be understood that the data involved in the technical solution (including but not limited to the data itself, the acquisition of the data, or the usage of the data) should comply with the requirements of corresponding laws, regulations, and related provisions.

In the current automatic image and text poster generation technology, the resulting image after arrangement/layout may usually has problems such as the text box position being uncoordinated and unattractive, or the text box obstructing the main body of the poster. In view of this, the present disclosure proposes an improved image and text typesetting scheme, which will be described below with reference to the accompanying drawings.

FIG. 1 is a flow chart of an image and text typesetting method according to an embodiment of the present disclosure.

As shown in FIG. 1, the image and text typesetting method includes the following steps S11 to S14.

In step S11, a saliency map can be acquired based on a background base image.

The background base image is an image on which material to be laid out will be placed.

The material to be laid out can be a text box or any other material.

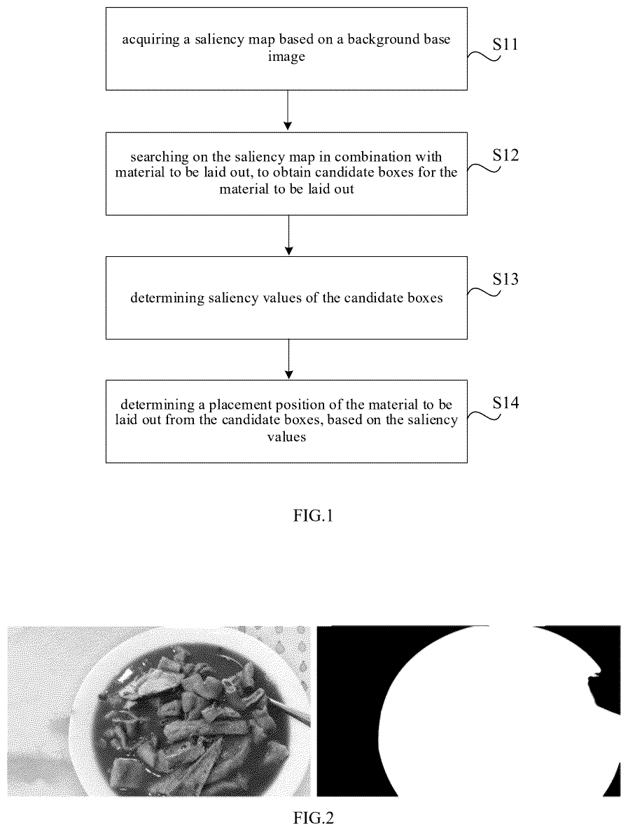

A saliency map is an image that illustrates a uniqueness of each pixel in the background base image. The size of the saliency map is the same as the background base image. FIG. 2 shows a schematic diagram of a background base image and its corresponding saliency map. In the saliency map on the right side of FIG. 2, the white part represents a salient region, and the black part represents a non-salient region.

In step S12, searching can be performed on the saliency map in combination with the material to be laid out, to obtain candidate boxes for the material to be laid out.

In some embodiments, the searching may be performed based on appearance parameters of the material to be laid out, such as size, shape, etc., for example, a box that can match the appearance of the material to be laid out can be found as a candidate box. In some embodiments, the searching may be performed on the saliency map in combination with the material to be laid out in a manner of window sliding. That is, a window in the shape of the material to be laid out can be used to perform a window sliding operation on the entire saliency map to obtain all candidate boxes where the material to be laid out can be placed. In particular, there may be one or more candidate boxes.

In step S13, the saliency values of the candidate boxes can be determined. In particular, the saliency value of each candidate box among all candidate boxes where the material to be laid out can be placed can be determined.

In some embodiments, an integral map of the saliency map may be determined first, and then the saliency value of each candidate box may be determined based on the integral map. The integral map refers to a map of integral values of each pixel in the image. The integral value of a pixel is the sum of all elements contained in a rectangle with the upper left pixel of the image as the upper left corner and the pixel as the lower right corner. By adopting the integral graph, the calculation speed of the saliency values can be accelerated.

In step S14, the placement position of the material to be laid out can be determined from the candidate boxes. In particular, a specific candidate box can be selected from all candidate boxes where the material to be laid out can be placed to place the material to be laid out.

For example, a candidate box with the smallest saliency value can be selected as the placement position of the material to be laid out; or the candidate boxes can be sorted according to the saliency values and N candidate boxes with the smallest saliency values can be selected, so that the user can autonomously decide which one in such N candidate boxes to place the material to be laid out.

It should be noted that, optionally, as an example, if only one candidate box is searched, there is no need to perform saliency value determination and selection based on the saliency values, and the searched candidate box can be directly used to place the material to be laid out. Of course, even if there is only one candidate box, the saliency value determination may be performed.

By adopting the above technical solution, since it is possible to acquire a saliency map based on a background base image; search on the saliency map in combination with material to be laid out to obtain candidate boxes for the material to be laid out; determine saliency values of the candidate boxes; determine a placement position of the material to be laid out from the candidate boxes based on the saliency values, therefore, it is possible to automatically lay out various materials (for example, text boxes and other materials) in the process of producing an image and text poster. Furthermore, since the placement position is determined based on the saliency values, it is possible to ensure that the material to be laid out is not placed in the salient region of the background base image, but is placed in the non-salient region of the background base image, which can greatly reduce the occlusion between the materials during the automatic layout process (for example, reduce the occlusion of the text box on the subject in the background base image), thereby improving the aesthetics of the automatically generated poster.

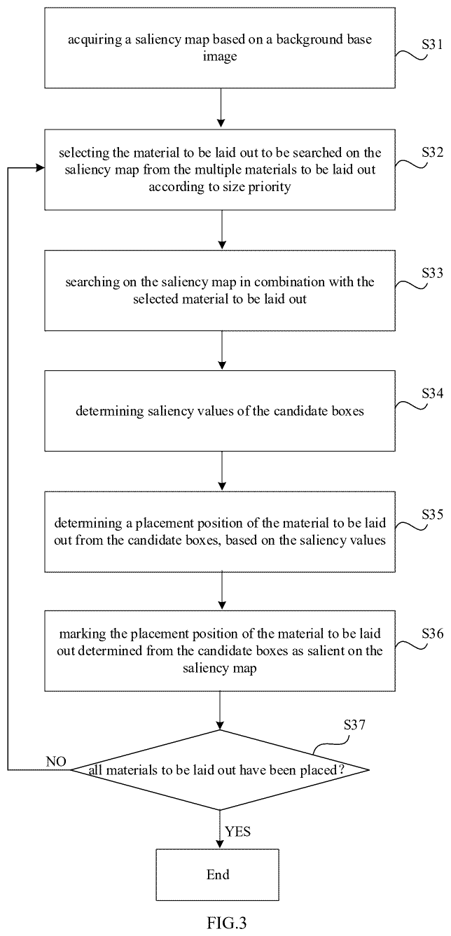

FIG. 3 is another flow chart of an image and text typesetting method according to an embodiment of the present disclosure.

As shown in FIG. 3, in step S31, a saliency map can be acquired based on the background base image.

In step S32, the material to be laid out to be searched on the saliency map can be selected from multiple materials to be laid out according to size priority. For example, multiple materials to be laid out may be sorted according to their area sizes, and the material to be laid out to be searched on the saliency map may be selected in descending order of size.

In step S33, the searching can be performed on the saliency map in combination with the selected material to be laid out to obtain candidate boxes for the selected material to be laid out. How to perform the searching has been described in detail hereinbefore, which will not be repeated here.

In step S34, the saliency values of the candidate boxes can be determined. How to determine the saliency values has been described in detail hereinbefore, which will not be repeated here.

In step S35, the placement position of the selected material to be laid out can be determined from the candidate boxes based on the saliency values.

In step S36, the determined placement position is marked as salient on the saliency map. In this way, the placement position will be considered as a salient region in the subsequent process where no other materials to be laid out will be placed.

In step S37, it is judged whether all the materials to be laid out have been placed. If all of the materials have been placed, the image and text typesetting process ends. If not all of the materials have been placed, then proceeds to step S32 to place the next material to be laid out.

By adopting the above technical solution, since it is possible to acquire a saliency map based on a background base image; search on the saliency map in combination with material to be laid out to obtain candidate boxes for the material to be laid out; determine saliency values of the candidate boxes; determine a placement position of the material to be laid out from the candidate boxes based on the saliency values, therefore, it is possible to automatically lay out various materials (for example, text boxes and other materials) in the process of producing an image and text poster, and, since the placement position is determined based on the saliency values, it is possible to ensure that the material to be laid out is not placed in the salient region of the background base image, but is placed in the non-salient region of the background base image, which can greatly reduce the occlusion between the materials during the automatic layout process (for example, reduce the occlusion of the text box on the subject in the background base image), thereby improving the aesthetics of the automatically generated poster.

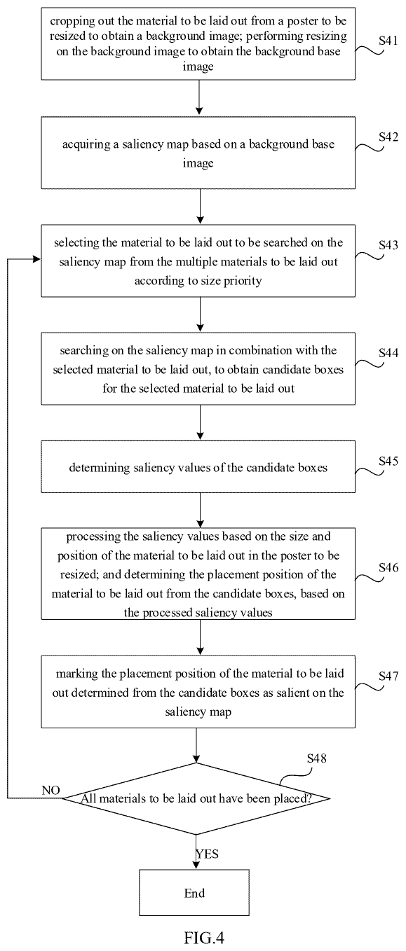

FIG. 4 is another flow chart of an image and text typesetting method according to an embodiment of the present disclosure. The image and text typesetting method can be applied to a scenario where an existing poster is resized to obtain a new poster, for example, an existing horizontal poster is resized to obtain a vertical poster.

As shown in FIG. 4, in step S41, the material to be laid out is cropped out from the poster to be resized to obtain a background image, and then the background image is resized to obtain a background base image.

For example, if it is desired to resize an existing horizontal poster to obtain a vertical poster, in step S41, it is possible to first crop out the material to be laid out (such as a text box) from the existing horizontal poster to obtain a background image, and then resize the background image to obtain a vertical background base image.

In step S42, a saliency map is acquired based on the background base image.

In step S43, the material to be laid out to be searched on the saliency map is selected from multiple materials to be laid out according to size priority. For example, multiple materials to be laid out may be sorted according to their area sizes, and the material to be laid out to be searched on the saliency map may be selected in descending order of size.

In step S44, the searching is performed on the saliency map in combination with the selected material to be laid out to obtain candidate boxes for the selected material to be laid out. How to perform the searching has been described in detail hereinbefore, which will not be repeated here.

In step S45, the saliency values of the candidate boxes are determined. How to determine the saliency values has been described in detail hereinbefore, which will not be repeated here.

In step S46, the saliency values are processed based on the position and size of the material to be laid out in the poster to be resized, and the placement position of the selected material to be laid out can be determined from the candidate boxes based on the processed saliency values.

In some embodiments, the processing of the saliency values based on the position and size of the material to be laid out in the poster to be resized can be implemented in the following way: first, calculating similarity between the position and size of a candidate box and the position and size of the material to be laid out in the poster to be resized, for example, if the position of the candidate box is relatively proximate to the position of the material to be laid out in the poster to be resized and the size of the candidate box is relatively similar to the size of the material to be laid out in the poster to be resized, the similarity between the candidate box and the material to be laid out is relatively high; then, normalizing the similarity, for example, the similarity is normalized to a range of 0 to 1; then, multiplying the normalized similarity by the saliency value to obtain the processed saliency value.

In step S47, the determined placement position is marked as salient on the saliency map. In this way, the placement position will be considered as a salient region in the subsequent process where no other materials to be laid out will be placed.

In step S48, it is judged whether all the materials to be laid out have been placed. If all of the materials have been placed, the image and text typesetting process ends. If not all of the materials have been placed, then proceeds to step S43 to place the next material to be laid out.

By adopting the above technical solution, since it is possible to acquire a saliency map based on a background base image; search on the saliency map in combination with material to be laid out to obtain candidate boxes for the material to be laid out; determine saliency values of the candidate boxes; determine a placement position of the material to be laid out from the candidate boxes based on the saliency values, therefore, it is possible to automatically lay out various materials (for example, text boxes and other materials) in the process of producing an image and text poster, and, since the placement position is determined based on the saliency values, it is possible to ensure that the material to be laid out is not placed in the salient region of the background base image, but is placed in the non-salient region of the background base image, which can greatly reduce the occlusion between the materials during the automatic layout process (for example, reduce the occlusion of the text box on the subject in the background base image), thereby improving the aesthetics of the automatically generated poster. In addition, since the position and size of the material to be laid out in the poster to be resized are taken into consideration when the placement position is determined, it can be ensured that the placement position finally determined is more appropriate.

In some embodiments, before searching on the saliency map in combination with the material to be laid out, the material to be laid out may be first subjected to multi-scale transformation, for example, the material to be laid out may be zoomed-in or zoomed-out, and the ratio of zooming-in or zooming-out may be within the range of 1 to 2 times. Through multi-scale transformation, materials to be laid out that retain the original size, materials to be laid out that are zoomed-in, materials to be laid out that are zoomed-out, etc., can be obtained. After the multi-scale transformation, the searching can be performed on the saliency map in combination with the materials to be laid out after the multi-scale transformation in sequence. For example, for the material to be laid out 1, assuming that after multi-scale transformation, a first-scale material to be laid out, a second-scale material to be laid out and a third-scale material to be laid out are obtained, then the searching can be performed on the saliency map in combination with the first-scale material to be laid out, the second-scale material to be laid out and the third-scale material to be laid out in sequence, so as to obtain the candidate boxes for the material to be laid out 1. This processing manner can also be called using a sliding window pyramid to extract candidate boxes of multiple scales. FIG. 5 shows a schematic diagram of extracting candidate boxes of multiple scales using a sliding window pyramid. Various rectangular boxes as shown in FIG. 5 are the extracted candidate boxes of multiple scales.

By performing multi-scale transformation on the material to be laid out and then performing the searching on the saliency map, it is possible to ensure that the material to be laid out is placed at a suitable position in the background base image.

In some embodiments, determining the placement position of the material to be laid out from the candidate boxes based on the saliency values can include: for candidate boxes whose positions are proximate to each other and whose difference in saliency values is less than a preset threshold, determining the placement position of the material to be laid out from the candidate boxes by using a non-maximum suppression method. This will ensure that a more appropriate placement position is determined for the material to be laid out.

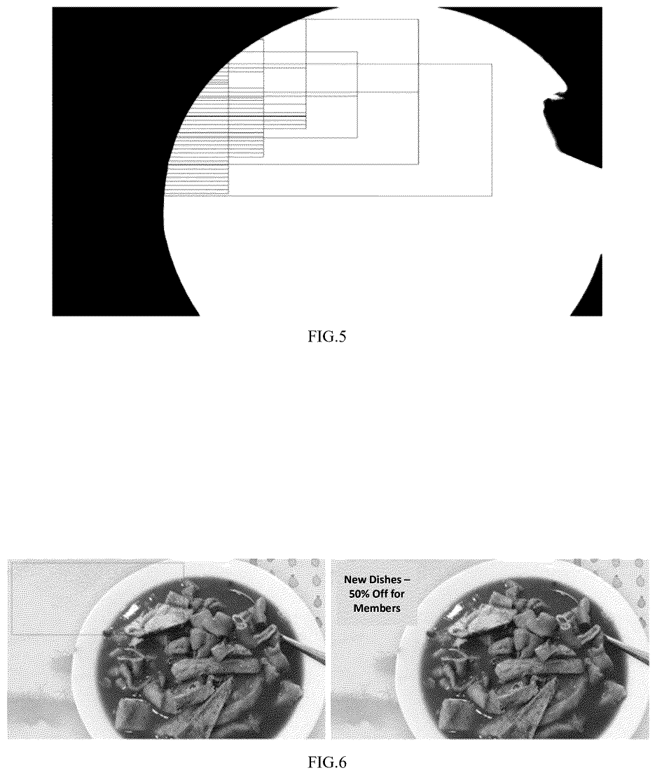

FIG. 6 is a schematic diagram of the placement position of the material to be laid out according to an embodiment of the present disclosure. In the left picture of FIG. 6, the rectangular box in the upper left corner is the candidate box position that is finally determined, and the upper left corner of the right picture shows the material to be laid out placed in the candidate box. It can be seen that the final placement position of the material to be laid out does not occlude the subject in the background base image.

The following will describe an image and text typesetting apparatus according to an embodiment of the present disclosure. The image and text typesetting apparatus provided in the embodiments of the present disclosure can execute the image and text typesetting method provided in any embodiment of the present disclosure. The embodiments of the present disclosure can divide the apparatus into functional units according to the above method examples. For example, each functional module/unit can be divided corresponding to each function, or two or more functions can be integrated into one processing module. It is worth noting that the various modules/units included in the above-mentioned apparatus are only divided according to functional logics, but not limited to the division described in the description, in actual implementation, there may be other division manners as long as the corresponding functions can be achieved; in addition, the specific names of the modules/units are only for the convenience of distinguishing each other, but are not used to limit the protection scopes of the embodiments of the present disclosure. Furthermore, each module/unit may be implemented in various appropriate ways, such as hardware, firmware, or any appropriate combination.

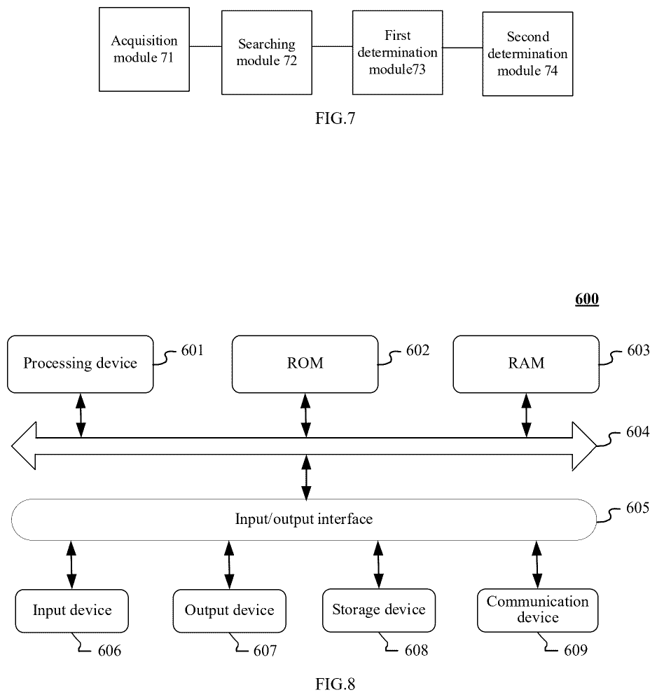

FIG. 7 is a schematic block diagram of an image and text typesetting apparatus according to an embodiment of the present disclosure. As shown in FIG. 7, the image and text typesetting apparatus may include: an acquisition module 71, configured to acquire a saliency map based on a background base image; a searching module 72, configured to search on the saliency map in combination with material to be laid out, to obtain candidate boxes for the material to be laid out; a first determination module 73, configured to determine saliency values of the candidate boxes; and a second determination module 74, configured to determine a placement position of the material to be laid out from the candidate boxes, based on the saliency values.

By adopting the above technical solution, since it is possible to acquire a saliency map based on a background base image; search on the saliency map in combination with material to be laid out to obtain candidate boxes for the material to be laid out; determine saliency values of the candidate boxes; determine a placement position of the material to be laid out from the candidate boxes based on the saliency values, therefore, it is possible to automatically lay out various materials (for example, text boxes and other materials) in the process of producing an image and text poster, and, since the placement position is determined based on the saliency values, it is possible to ensure that the material to be laid out is not placed in the salient region of the background base image, but is placed in the non-salient region of the background base image, which can greatly reduce the occlusion between the materials during the automatic layout process (for example, reduce the occlusion of the text box on the subject in the background base image), thereby improving the aesthetics of the automatically generated poster.

In some exemplary embodiments, there are multiple materials to be laid out, and the searching module 72 may be further configured to: select the material to be laid out to be searched on the saliency map from the multiple materials to be laid out according to size priority, and search on the saliency map in combination with the selected material to be laid out.

In some exemplary embodiments, the search module 72 may be further configured to: perform multi-scale transformation on the material to be laid out, and search on the saliency map in sequence based on the material to be laid out after multi-scale transformation.

In some exemplary embodiments, the first determination module 73 may be further configured to: determine an integral map of the saliency map, and determine the saliency values of the candidate boxes, based on the integral map.

In some exemplary embodiments, the image and text typesetting apparatus may further include a marking module configured to: mark the placement position of the material to be laid out determined from the candidate boxes as salient on the saliency map, after determination of the placement position.

In some exemplary embodiments, the image and text typesetting apparatus may further include a cropping module configured to: crop out the material to be laid out from a poster to be resized to obtain a background image; resizing the background image to obtain the background base image;

The second determination module 74 may be further configured to: process the saliency values based on the size and position of the material to be laid out in the poster to be resized; and determine the placement position of the material to be laid out from the candidate boxes, based on the processed saliency values.

In some exemplary embodiments, the second determination module 74 may be further configured to: calculate a similarity between the size and position of a candidate box and the size and position of the material to be laid out in the poster to be resized; normalize the similarity; multiply the normalized similarity by the saliency value, to obtain the processed saliency value.

In some exemplary embodiments, the second determination module 74 may be further configured to: for candidate boxes whose positions are proximate to each other and whose difference in saliency values is less than a preset threshold, determining the placement position of the material to be laid out from the candidate boxes by using a non-maximum suppression method.

An embodiment of the present disclosure further provides a computer-readable medium having a computer program stored thereon, where the computer program, when executed by a processing device, can implement the steps of any method in the present disclosure.

An embodiment of the present disclosure further provides an electronic device, comprising: a storage device on which a computer program is stored; and a processing device configured to execute the computer program in the storage device to implement the steps of any method in the present disclosure.

The solutions proposed by the embodiments of the present disclosure have been described above. It can be understood that, in order to realize the above functions, the electronic device includes corresponding hardware structures and/or software modules for executing various functions. Those skilled in the art should readily appreciate that, in combination with the units and algorithm steps of the various examples described in the embodiments disclosed herein, the present disclosure can be implemented in the form of hardware or a combination of hardware and computer software. Whether a function is performed by hardware or by computer software driving hardware depends on the specific application and design constraints of the technical solution. A skilled person may use different methods to implement the described functionality for each specific application, but such implementation should not be considered to be beyond the scope of the present disclosure.

Hereinafter reference will be made with reference to FIG. 8, which illustrates a structural schematic diagram of an electronic device (such as a terminal device or a server) 600 suitable for implementing the embodiments of the present disclosure. The electronic devices in the embodiments of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV and desktop computers. The electronic device shown in FIG. 8 is only an example, and should not bring any limitation to the functions and application scopes of the embodiments of the present disclosure.

As shown in FIG. 8, an electronic device 600 may include a processing device (such as a central processing unit, a graphic processor, etc.) 601, which may perform various appropriate actions and processes according to a program stored in a read-only memory (ROM) 602 or a program loaded from a storage device 608 into a random-access memory (RAM) 603. In the RAM 603, various programs and data required for the operation of electronic device 600 are also stored. A processing device 601, a ROM 602 and a RAM 603 are connected to each other through a bus 604. An input/output (I/O) interface 605 is also connected to the bus 604.

Generally, the following devices can be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. Although FIG. 8 shows an electronic device 600 with various devices, it should be understood that it is not required to implement or have all the devices as shown. More or fewer devices may alternatively be implemented or provided.

In particular, according to embodiments of the present disclosure, the processes described above with reference to the flowcharts can be implemented as a computer software program. For example, an embodiment of the present disclosure includes a computer program product including a computer program carried on a non-transitory computer-readable medium, which contains program codes for executing the methods shown in the flowcharts. In such an embodiment, the computer program can be downloaded and installed from the network through the communication device 609, or installed from the storage device 608, or installed from the ROM 602. When the computer program is executed by the processing device 601, the above functions defined in the methods of the embodiments of the present disclosure can be implemented.

It should be noted that the computer-readable medium mentioned above in the present disclosure can be a computer-readable signal medium or a computer-readable storage medium or any combination of such two. The computer-readable storage medium can be, for example, but not limited to, an electrical, magnetic, optical, electromagnetic, infrared, or semiconductor system, apparatus or device, or a combination of the above. More specific examples of computer-readable storage media may include, but not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, and can send, propagate or transmit a program for use by or in connection with an instruction execution system, apparatus or device. The program codes contained in the computer-readable medium can be transmitted by any suitable medium, including but not limited to wires, optical cables, RF (radio frequency) and the like, or any suitable combination of the above.

In some embodiments, the electronic devices can communicate with each other by using any currently known or future to-be-developed network protocol such as HTTP (HyperText Transfer Protocol), and can be interconnected with digital data communication in any form or medium (for example, communication network). Examples of communication networks include a local area network (“LAN”), a wide area network (“WAN”), an internet network (for example, Internet) and end-to-end networks (for example, ad hoc end-to-end networks), as well as any currently known or future to-be-developed networks.

The computer-readable medium may be included in the above electronic device; or it can exist alone without being assembled into the electronic device. The computer-readable medium carries one or more programs, and when the one or more programs are executed by the electronic device, the electronic device is caused to perform the image and text typesetting method provided in any embodiment of the present disclosure.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program codes can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architectures, functions and operations of possible implementations of systems, methods and computer program products according to various embodiments of the present disclosure. In this regard, each block in the flowchart or block diagram may represent a module, a program clip, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The modules involved in the embodiments described in the present disclosure can be realized by software or hardware. Among them, the name of the module does not constitute the limitation of the module itself in some cases. For example, the acquisition unit may also be described as a “module for acquiring a saliency map based on a background base image”.

The functions described above herein may be at least partially performed by one or more hardware logic components. For example, without limitation, exemplary types of hardware logic components that can be used may include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, Example 1 provides an image and text typesetting method, including: acquiring a saliency map based on a background base image; searching on the saliency map in combination with material to be laid out, to obtain candidate boxes for the material to be laid out; determining saliency values of the candidate boxes; determining a placement position of the material to be laid out from the candidate boxes, based on the saliency values.

According to one or more embodiments of the present disclosure, Example 2 provides the method of Example 1, wherein there are multiple materials to be laid out, and the method further includes: selecting the material to be laid out to be searched on the saliency map from the multiple materials to be laid out according to size priority;
the searching on the saliency map in combination with the material to be laid out includes: searching on the saliency map in combination with the selected material to be laid out.

According to one or more embodiments of the present disclosure, Example 3 provides the method of Example 1, wherein the method further includes: performing multi-scale transformation on the material to be laid out;
the searching on the saliency map in combination with the material to be laid out includes: searching on the saliency map in sequence based on the material to be laid out after multi-scale transformation.

According to one or more embodiments of the present disclosure, Example 4 provides the method of Example 1, wherein the determining the saliency values of the candidate boxes includes: determining an integral map of the saliency map; determining the saliency values of the candidate boxes, based on the integral map.

According to one or more embodiments of the present disclosure, Example 5 provides the method of Example 1, wherein the method further includes: marking the placement position of the material to be laid out determined from the candidate boxes as salient on the saliency map, after determination of the placement position.

According to one or more embodiments of the present disclosure, Example 6 provides the method of any one of Examples 1 to 5, wherein the method further includes: cropping out the material to be laid out from a poster to be resized to obtain a background image; resizing the background image to obtain the background base image;
the determining the placement position of the material to be laid out from the candidate boxes, based on the saliency values, includes: processing the saliency values based on the size and position of the material to be laid out in the poster to be resized; and determining the placement position of the material to be laid out from the candidate boxes, based on the processed saliency values.

According to one or more embodiments of the present disclosure, Example 7 provides the method of Example 6, wherein the processing the saliency values based on the size and position of the material to be laid out in the poster to be resized, includes: calculating a similarity between the size and position of a candidate box and the size and position of the material to be laid out in the poster to be resized; normalizing the similarity; multiplying the normalized similarity by the saliency value, to obtain the processed saliency value.

According to one or more embodiments of the present disclosure, Example 8 provides the method of any one of Examples 1 to 5 and 7, wherein the determining a placement position of the material to be laid out from the candidate boxes, based on the saliency values, includes: for candidate boxes whose positions are proximate to each other and whose difference in saliency values is less than a preset threshold, determining the placement position of the material to be laid out from the candidate boxes by using a non-maximum suppression method.

According to one or more embodiments of the present disclosure, Example 9 provides an image and text typesetting apparatus, includes: an acquisition module, configured to acquire a saliency map based on a background base image; a searching module, configured to search on the saliency map in combination with material to be laid out, to obtain candidate boxes for the material to be laid out; a first determination module, configured to determine saliency values of the candidate boxes; a second determination module, configured to determine a placement position of the material to be laid out from the candidate boxes, based on the saliency values.

According to one or more embodiments of the present disclosure, Example 10 provides a computer-readable medium storing a computer program and/or instructions thereon, wherein the computer program and/or instructions, when executed by a processing device, cause the processing device to implement the steps in the method according to any one of Examples 1-8.

According to one or more embodiments of the present disclosure, Example 11 provides an electronic device, including: a storage device storing a computer program and/or instructions thereon, and a processing device, configured to execute the computer program and/or instructions in the storage device to implement the steps in the method according to any one of Examples 1-8.

According to one or more embodiments of the present disclosure, Example 12 provides a computer program product comprising instructions which, when executed by a processor, causes the processor to implement the steps in the method according to any one of Examples 1-8.

According to one or more embodiments of the present disclosure, Example 13 provides a computer program comprising program codes, which, when executed by a processor, cause implementation of the steps in the method according to any one of Examples 1-8.

The above description is only a preferred embodiment of the present disclosure and an illustration of the technical principles used. Those skilled in the art should understand that the scope of disclosure involved in the present disclosure is not limited to the technical solutions formed by a specific combination of the above-mentioned technical features, but should also cover other technical solutions formed by any combination of the above-mentioned technical features or their equivalent features without departing from the above-mentioned disclosure concepts. For example, the above-mentioned features are replaced with the technical features with similar functions disclosed in this disclosure (but not limited to) to form a technical solution.

Further, while operations are depicted in a particular order, this should not be understood as requiring that such operations be performed in the particular order shown or in a sequential order. Under certain circumstances, multitasking and parallel processing may be advantageous. Likewise, while the above discussion includes several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims. With respect to the apparatuses in the above embodiments, specific manners of operations of the various modules in the apparatuses have been described in detail in the method embodiments, and will not be described in detail here.

1. An image and text typesetting method, comprising:
acquiring a saliency map based on a background base image;
searching on the saliency map in combination with material to be laid out, to obtain candidate boxes for the material to be laid out;
determining saliency values of the candidate boxes;
determining a placement position of the material to be laid out from the candidate boxes, based on the saliency values.

2. The method according to claim 1, wherein there are multiple materials to be laid out, and the method further comprises: selecting the material to be laid out to be searched on the saliency map from the multiple materials to be laid out according to size priority;
the searching on the saliency map in combination with the material to be laid out comprises: searching on the saliency map in combination with the selected material to be laid out.

3. The method according to claim 1, wherein the method further comprises:
performing multi-scale transformation on the material to be laid out;
the searching on the saliency map in combination with the material to be laid out comprises: searching on the saliency map in sequence based on the material to be laid out after multi-scale transformation.

4. The method according to claim 1, wherein the determining the saliency values of the candidate boxes, comprises:
determining an integral map of the saliency map;
determining the saliency values of the candidate boxes, based on the integral map.

5. The method according to claim 1, wherein the method further comprises:
marking the placement position of the material to be laid out determined from the candidate boxes as salient on the saliency map, after determination of the placement position.

6. The method according to claim 1, wherein the method further comprises: cropping out the material to be laid out from a poster to be resized to obtain a background image; resizing the background image to obtain the background base image;
the determining the placement position of the material to be laid out from the candidate boxes, based on the saliency values, comprises: processing the saliency values based on the size and position of the material to be laid out in the poster to be resized; and determining the placement position of the material to be laid out from the candidate boxes, based on the processed saliency values.

7. The method according to claim 6, wherein the processing the saliency values based on the size and position of the material to be laid out in the poster to be resized, comprises:
calculating a similarity between the size and position of a candidate box and the size and position of the material to be laid out in the poster to be resized;
normalizing the similarity;
multiplying the normalized similarity by the saliency value, to obtain the processed saliency value.

8. The method according to claim 1, wherein the determining the placement position of the material to be laid out from the candidate boxes, based on the saliency values, comprises: for candidate boxes whose positions are proximate to each other and whose difference in saliency values is less than a preset threshold, determining the placement position of the material to be laid out from the candidate boxes by using a non-maximum suppression method.

9. (canceled)

10. A non-transitory computer-readable storage medium storing a computer program thereon, wherein the computer program, when executed by a processing device, cause the processing device to implement:
acquiring a saliency map based on a background base image;
searching on the saliency map in combination with material to be laid out, to obtain candidate boxes for the material to be laid out;
determining saliency values of the candidate boxes;
determining a placement position of the material to be laid out from the candidate boxes, based on the saliency values.

11. An electronic device, comprising
a storage device storing a computer program thereon, and
a processing device, configured to execute the computer program in the storage device to implement:
acquiring a saliency map based on a background base image;
searching on the saliency map in combination with material to be laid out, to obtain candidate boxes for the material to be laid out;
determining saliency values of the candidate boxes;
determining a placement position of the material to be laid out from the candidate boxes, based on the saliency values.

12-13. (canceled)

14. The non-transitory computer-readable storage medium according to claim 10, wherein the computer program, when executed by the processing device, cause the processing device to select the material to be laid out to be searched on the saliency map from a multiple materials to be laid out according to size priority, and the searching on the saliency map in combination with the material to be laid out comprises: searching on the saliency map in combination with the selected material to be laid out, or
wherein the computer program, when executed by the processing device, cause the processing device to perform multi-scale transformation on the material to be laid out, and the searching on the saliency map in combination with the material to be laid out comprises: searching on the saliency map in sequence based on the material to be laid out after multi-scale transformation.

15. The non-transitory computer-readable storage medium according to claim 10, wherein the determining the saliency values of the candidate boxes, comprises:
determining an integral map of the saliency map;
determining the saliency values of the candidate boxes, based on the integral map.

16. The non-transitory computer-readable storage medium according to claim 10, wherein the computer program, when executed by the processing device, cause the processing device to implement: cropping out the material to be laid out from a poster to be resized to obtain a background image; resizing the background image to obtain the background base image;
the determining the placement position of the material to be laid out from the candidate boxes, based on the saliency values, comprises: processing the saliency values based on the size and position of the material to be laid out in the poster to be resized; and determining the placement position of the material to be laid out from the candidate boxes, based on the processed saliency values.

17. The non-transitory computer-readable storage medium according to claim 16, wherein the processing the saliency values based on the size and position of the material to be laid out in the poster to be resized, comprises:
calculating a similarity between the size and position of a candidate box and the size and position of the material to be laid out in the poster to be resized;
normalizing the similarity;
multiplying the normalized similarity by the saliency value, to obtain the processed saliency value.

18. The non-transitory computer-readable storage medium according to claim 10, wherein the determining the placement position of the material to be laid out from the candidate boxes, based on the saliency values, comprises: for candidate boxes whose positions are proximate to each other and whose difference in saliency values is less than a preset threshold, determining the placement position of the material to be laid out from the candidate boxes by using a non-maximum suppression method.

19. The electronic device according to claim 11, wherein the processing device is further configured to execute the computer program in the storage device to select the material to be laid out to be searched on the saliency map from a multiple materials to be laid out according to size priority, and the searching on the saliency map in combination with the material to be laid out comprises: searching on the saliency map in combination with the selected material to be laid out, or
wherein the processing device is further configured to execute the computer program in the storage device to perform multi-scale transformation on the material to be laid out, and the searching on the saliency map in combination with the material to be laid out comprises: searching on the saliency map in sequence based on the material to be laid out after multi-scale transformation.

20. The electronic device according to claim 11, wherein the determining the saliency values of the candidate boxes, comprises:
determining an integral map of the saliency map;
determining the saliency values of the candidate boxes, based on the integral map.

21. The electronic device according to claim 11, wherein the processing device is further configured to execute the computer program in the storage device to implement: cropping out the material to be laid out from a poster to be resized to obtain a background image; resizing the background image to obtain the background base image;
the determining the placement position of the material to be laid out from the candidate boxes, based on the saliency values, comprises: processing the saliency values based on the size and position of the material to be laid out in the poster to be resized; and determining the placement position of the material to be laid out from the candidate boxes, based on the processed saliency values.

22. The electronic device according to claim 21, wherein the processing the saliency values based on the size and position of the material to be laid out in the poster to be resized, comprises:
calculating a similarity between the size and position of a candidate box and the size and position of the material to be laid out in the poster to be resized;
normalizing the similarity;
multiplying the normalized similarity by the saliency value, to obtain the processed saliency value.

23. The electronic device according to claim 11, wherein the determining the placement position of the material to be laid out from the candidate boxes, based on the saliency values, comprises: for candidate boxes whose positions are proximate to each other and whose difference in saliency values is less than a preset threshold, determining the placement position of the material to be laid out from the candidate boxes by using a non-maximum suppression method.
